(19) United States
(12) Patent Application Publication
(10) Pub. No.: US 2012/0136478 A1
(43) Pub. Date: May 31, 2012

(54) System and Method for Human Interface To A Vending Machine

(75) Inventors: Minakshisundaran Anand, Germantown, MD (US); Timothy Clark Winter, Frederick, MD (US); Anders Mikael Jagd, Great Falls, VA (US); Vinod Sitaram Mukkamala, Leesburg, VA (US); Prakash Chakravarthi, Gaithersburg, MD (US)

(73) Assignee: Agleo, LLC, Germantown, MD (US)

(21) Appl. No.: 12/956,995

(22) Filed: Nov. 30, 2010

(51) Int. Cl. G06F 17/00; H04W 4/00; G06F 15/16

(52) U.S. Cl. 700/237; 709/201; 709/203; 455/414.1

(57) ABSTRACT

A system and a method for human interface to a vending machine are provided. The system includes sensing devices located in a vending machine that are capable of detecting user actions such as knocking, thumping or slapping on the vending machine. The system also includes similar sensing devices in interface devices possessed by the user. The signals generated in the sensing devices located in the vending machine and the sensing devices in interface devices are compared and matched according to several criteria in a server computer. Based upon a successful match, vending services are enabled and the user is charged to an account for the products dispensed.

### BACKGROUND

Automated vending machines have a long history; their use has been traced to at least 200 BC, in ancient Greece. Beginning in the Industrial Age in the late 19^{th} century, however, vending machines came into prominence and widespread public use. Today, vending machines are used for dispensing a wide variety of goods, including beverages, food, candy, newspapers, tobacco, etc.

During all this time, however, the interface between users and vending machines has largely remained the same. That is, the person operating the vending machine inserts a coin or paper currency bills, the machine validates the cash, and dispenses the goods and, possibly, change. While this user interface has withstood the test of time, it has not been without problems, all of which are familiar to practically everyone in modern society. Some examples of the problems are: the user might not have sufficient coins, bills are rejected or get stuck, etc. All of these issues lead to reduced sales for the operator of the vending service, and frustration for the user.

Accordingly, equipping vending machines with cashless transactional capability is of great interest to the vending industry, and efforts are under way in this regard. See, e.g., “Experts Review Progress in Cashless Payment; Option Can Please Patrons and Generate Lift In Vending Sales,” Vending Times, vol. 48, no. 7, July 2008. Traditionally, these efforts have focused on equipping vending machines with credit/debit card readers. However, both the costs associated with the card-reading equipment, as well as the transaction fees associated with each credit or debit card transaction, are high. Since the typical purchase from a vending machine involves relatively small monetary transactions, these high costs pose a problem for the vending service operator. Moreover, a credit card transaction involves the user swiping the card, waiting for approval of transaction, and confirming the purchase—multiple steps to complete a simple transaction. From the perspective of user convenience, the credit/debit card alternative is, therefore, not very desirable. This fact has further led the vending industry to explore alternative cashless transaction means such as pre-paid cards or Radio Frequency Identification (RFID) equipped smart cards. However, such cards are not widely possessed by the general public, and therefore, are not a very convenient means of vending machine purchases for the customer.

On a related, but separate track, in conjunction with the advent of the Internet and mobile phones, there have been efforts to allow consumers to request products from vending machines through an application available on their mobile phone. For example, there is the “Dial-a-Coke” technology tested by Coca-Cola, as described in “Coca-Cola Customers to Buy Drinks From Vending Machines Using Marconi's GSM . . . ,” Business Wire, dated Feb. 7, 2001). This, and other related technologies, require the consumer to look up the telephone number or network address of the vending machine they are trying to interact with using their mobile phone or computer, and request a purchase. The charge for the product dispensed is then added to the user's online account. While this interface eliminates direct credit/debit/smart card interaction with the vending machine, it still suffers from the disadvantage of being a complex interface requiring the user to complete multiple steps—looking up the vending machine, selecting a product from a menu in the computer or mobile device in order to complete a simple transaction. A similar, but slightly different interface proposed by the company Vendtxt Vending, Inc. involves the user sending a text message incorporating a vending machine identification code to a pre-determined service number, and then the system issuing the user an authorization code via text message, which the consumer then inputs into the vending machine to obtain the product desired. As can be seen, this interface too suffers from the same disadvantage of multiple steps being involved to complete a simple transaction. Further, the cost of fitting the vending machine with equipment to input the authorization code and receive and authorize the codes may be relatively high as well.

In essence, no current vending machine interface technology offers the right balance between cost, ease-of-use and the convenience of cashless transactions.

### SUMMARY

An advantage of embodiments described herein is that they overcome the disadvantages of the prior art. These advantages and others are achieved, for example, by a system for interactive use of automated vending machines. The system includes a server computer, one or more vending machines, each of the one or more vending machines including, one or more first sensing devices capable of detecting forces exerted on an external surface of the vending machine, a first communications device capable of communications between the vending machine and the server computer, and a first control module coupled to at least the one or more first sensing devices and the first communications device, and one or more human interface devices capable of being held by, worn by, or carried in or on the person of a human, each of the human interface devices including one or more second sensing devices capable of detecting forces exerted on a surface of the human interface device while the human interface device is held, worn or carried, a second communications device capable of communications between the human interface device and the server computer, and a second control module coupled to at least the one or more second sensing devices and the second communications device.

These advantages and others are also achieved by a method for interactive use of automated vending machines. The method includes detecting a force exerted on an external surface of a vending machine, generating a first signal corresponding to the force, communicating the first signal from the vending machine to a server computer, receiving a second signal from the human interface device at the server computer, the second signal generated in response to the force being detected in a human interface device, detecting a match between the first signal and the second signal, the match indicating an association between the vending machine, the human interface device, and the force, communicating an authorization message from the server computer to the vending machine, receiving the authorization message at the vending machine, and subsequent to receiving the authorization message, dispensing one or more selected objects the one or more objects.

These advantages and others are also achieved by, for example, a system for interactive use of automated vending machines. The system includes a server computer, one or more vending machines, each of the one or more vending machines including one or more first sensing devices capable of detecting forces exerted on an external surface of the vending machine, when a user exerts a force on the external surface of a vending machine, the one or more sensing devices detects the force and generates a first signal indicative of the force, a first communications device capable of communications between the vending machine and the server computer, the first communications device communicates the signal to the server computer, and a first control module coupled to at least the one or more first sensing devices and the first communications device. The server computer receives a second signal indicative of the force and compares the first signal to the second signal, and if there is a match between the first signal and the second signal, the server computer communicates an authorization message to the first control module authorizing the vending machine to dispense items selected by a user.

### DESCRIPTION OF THE DRAWINGS

The detailed description will refer to the following drawings, wherein like numerals refer to like elements, and wherein:

FIG. 1 is a block diagram illustrating an embodiment of a system for interactive use of automated vending machines.

FIG. 2 is a flow diagram illustrating an embodiment of a method for interactive use of automated vending machines.

FIG. 3 is a flow diagram illustrating an embodiment of a method for interactive use of automated vending machines.

FIG. 4 is a flow diagram illustrating an embodiment of a method for interactive use of automated vending machines.

FIG. 5 is a flow diagram illustrating an embodiment of a method for interactive use of automated vending machines.

FIG. 6 is a block diagram illustrating an embodiment of a system for interactive use of automated vending machines.

### DETAILED DESCRIPTION

Described herein are a system and method for users to interact with automatic vending machines in order to make purchases. As noted above, systems known in the art at present suffer numerous problems, all of which are overcome by embodiments described herein. By providing an intuitive, simple, cashless interface that allows completion of a purchase at a vending machine in a single step, embodiments solve the fundamental transactional issues associated with the human interface to vending machines. Moreover, the embodiments of the system and method described herein also provide several other advantages that are realized for the first time.

In embodiments, the interface automatically incorporates an engaging and fun aspect into the act of making a purchase from a vending machine. This aspect can lead to further increase in sales from vending machines over and above the increases generated purely from the cashless convenience aspect. A further advantage is that embodiments allow an operator of the vending service to construct and conduct innovative marketing campaigns around the consumer interaction with the vending machine, converting the vending machine into a marketing aid, and leading to potentially improved sales. Perhaps more importantly, embodiments allow such marketing campaigns to be conducted on a highly targeted basis, directed at each individual consumer, or each individual vending machine, or a combination of both. Yet another advantage is that embodiments automatically provide a wealth of data regarding consumer buying habits to the vending service operator without the operator incurring any added cost. Such data is invaluable for vending service operators in analyzing and understanding the consumer buying experience, with a view to improving this experience and thus obtaining increased revenue.

These and other advantages are achieved by embodiments through equipping the vending machines with devices that can sense a user knocking, thumping or slapping the vending machine while holding, carrying or wearing a mobile phone or other gadgets that are also equipped with similar sensing devices. Examples of devices that can sense such actions by the user are accelerometers. In embodiments, when the user simply knocks, thumps or slaps a vending machine with a mobile phone in hand, the sensing devices in both the vending machine and the phone detect this action and transmit a signature characterizing the action to a central server. The server matches individual actions to vending machines based on the signatures sent by both the machine and the mobile phone held by the user. Consequently, the server can know both the user who is performing the action as well as the vending machine on which the action is being taken and communicates an authorization message to the vending machine. Thereafter, when the user makes a selection at the machine and the product is dispensed, the vending machine informs the server and the user is charged for the product, either through the mechanism of adding to the user's mobile phone bill, or through other convenient means. Accordingly, embodiments present an intuitive, simple interface to the vending machine that comprises a single physical action that is very familiar to all users.

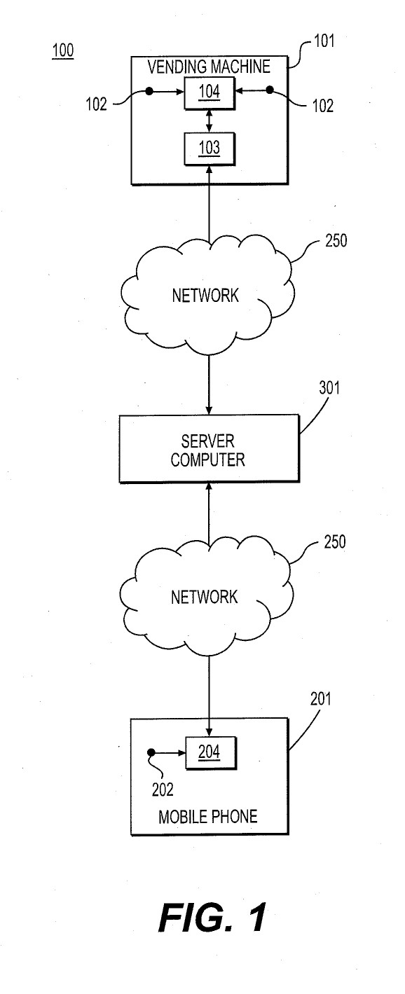

With reference now to FIG. 1, shown is an embodiment of system 100 for interactive use of automated vending machines System 100 may include one or more automatic vending machines 101. Vending machine 101 is equipped with one or more sensing devices 102 capable of sensing acceleration resulting from the application of a sudden force, such as that resulting from a knock, thump or a slap applied by human fist or hand against a surface. In the descriptions that follow, the terms knocking, thumping or slapping are used interchangeably, and it is to be understood that any one of these actions can be interchanged with another. One example of such a sensing device 102 is an accelerometer. Highly miniaturized accelerometers based on Microelectromechanical Systems (MEMS) accelerometers are widely available and are capable of detecting accelerations in 2 or 3 axes. According to embodiments of system 100, sensing devices 102 may be located either on the inside or the outside surfaces of the vending machine 101. Sensing devices 102 may also be located on the front surface of vending machine 101 or on the side surfaces. Further, embodiments may also incorporate a single sensing device 102 or multiple devices 102 distributed at various locations in vending machine 101.

As shown, system 100 also includes one or more communication devices 103, which provide for data communications between vending machine 101 and (typically remote) server computer 301. Communications device 103 may be, e.g., a cellular modem, or similar device, that is capable of communicating with the server 301 over the Internet or other network 250. Alternatively, communications device 103 may also be a telephone modem, or similar device, that communicates over telephone lines. Both cellular and telephone line modems are well-known and widely available. Furthermore, communications device 103 may be shared between multiple vending machines using serial bus technologies, wireless or wired local area networking (LAN) technologies, or other network technologies. Such technologies are well-known in the art. The server computer 301 may, for example, be owned and operated by the operator of the vending service, the manufacturer of the products dispensed, the owner of the brand of the products being dispensed, or a third party service operator. The server computer 301 may be any computing device specifically programmed or running software applications to perform the methods, steps and actions described herein. The server computer 301 may include one or more processors, memory, secondary storage devices (e.g., hard drives), input, output and display devices. The vending machine 101 may also be provided with a control module 104 that is operationally coupled to sensing devices 102 and communications device 103. Control module 104 could, for example, include a microcontroller executing a software program to perform methods and functions described herein.

With continuing reference to FIG. 1, embodiments of system 100 may also include one or more mobile phones 201. Mobile phone 201 may be any processor equipped mobile phone, including such smart-phones as the iPhone, Android, etc. Mobile phone 201 is equipped with sensing devices 202, which may be similar to those in vending machine 102. Accelerometer-equipped mobile phones have also become widely available. Mobile phone 201 may also be equipped with a control module 204, which may, e.g., be a software program that is operationally coupled to both sensing devices 202, and wireless communication means inherent in the mobile phone 201.

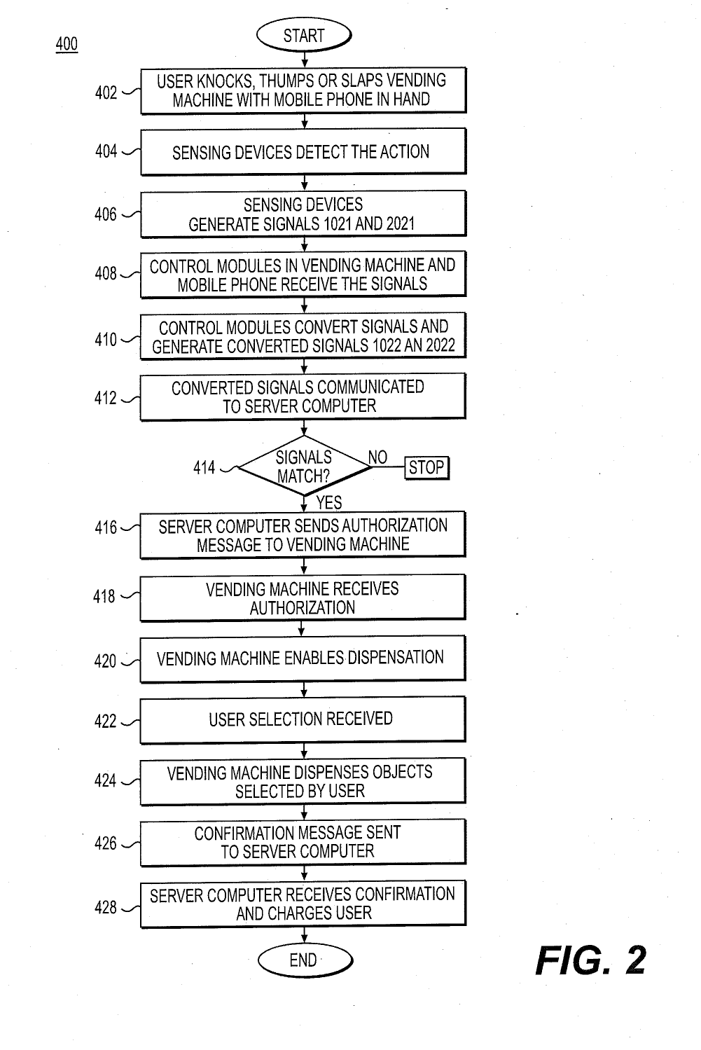

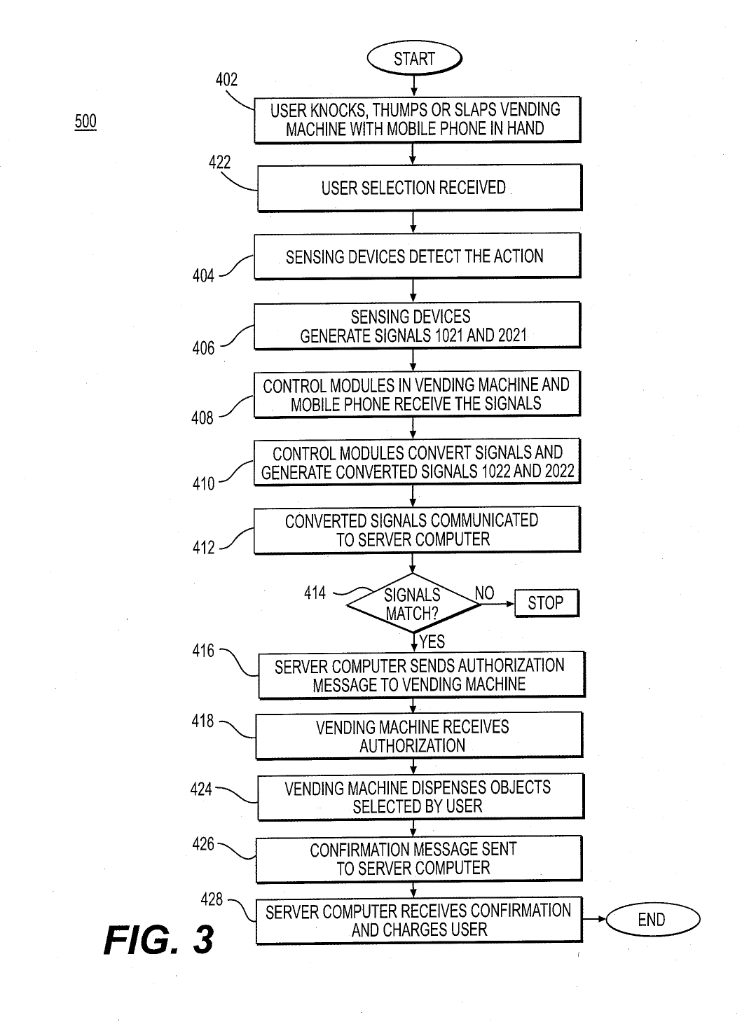

With continuing reference to FIG. 1 and reference now to FIG. 2, shown is an embodiment of a method 400 for interactive use of automated vending machines. With mobile phone 201 in hand, a user knocks, thumps or slaps the vending machine 101, block 402.

Sensing devices 102 and 202, located in the vending machine 101 and the mobile phone 201, respectively, detect the force exerted by the user's action, block 404. Sensing devices 102 and 202 then provide signals 1021 and 2021 corresponding to their respective sensed physical quantities, block 406. If the sensing devices 102 and 202 are, for example, accelerometers, the signals 1021 and 2021 would be time-varying functions proportional to the acceleration produced at their respective locations due to the force exerted by the user's action.

Control modules 104 and 204, located respectively in the vending machine and the mobile phone, receive the signals 1021 and 2021, block 408. The reception of the signal 1021 by control module 104 may, e.g., occur over a hardware interface (not shown) that operatively couples control module 104 to sensing devices 102, the hardware interface in turn being controlled by software programs executed by control module 104. The reception of the signal 2021 by control module 204 may, e.g., occur via software drivers or software interfaces provided by the operating system in mobile phone 201.

With continuing reference to FIGS. 1 and 2, control modules 104 and 204 convert the signals 1021 and 2021, to forms 1022 and 2022 respectively that are suitable for communication to the server computer 301, block 410. In an embodiment, the conversion 410 includes at least adding information identifying the source of the communication, such as, for example, a unique identifier associated with vending machine 101 and mobile phone 201. The conversion 410 may also include adding information regarding the time at which the signals 1021 and 2021 were sensed. The conversion 410 may also include adding information regarding the physical location of the mobile phone and vending machine The physical location information may be relatively precise, as would be the case if it were to be obtained from Global Positioning Satellite (GPS) receivers (not shown) included in vending machine 101 and mobile phone 201. Alternatively, the location may be relatively coarse and include, e.g., identification of the nearest cellular base stations that are in communication with mobile phone 201 or communications device 103 provided in vending machine 101. With regard to the signals 1021 and 2021, conversion 410 may, e.g., include simply packetizing the signals. Alternatively, conversion 410 may, e.g., include compressing the signals using well-known compression algorithms, extracting a digest that describes the salient characteristics of the signal, and/or adding other pertinent information describing characteristics of the signals.

Control modules 104 and 204 communicate their respective converted forms of the signals 1022 and 2022 to the server computer 301, block 412. Control module 104 conducts this communication using communications device 103, whereas control module 204 conducts this communication using the mobile communications facility inherent in mobile phone 201. Communication 412 may be conducted over a secure communications channel, may occur in encrypted form and may, e.g., include steps to mutually authenticate the communicating devices.

Server computer 301 compares the received forms 1022 and 2022 with the objective of determining a match between the two, block 414. Method 400 performs matching 414 because, although FIG. 2 only shows communications received from a single vending machine 101 and a single mobile phone 201, in practice numerous vending machines and mobile phones will be communicating their respective converted forms of detected signals, which together will constitute a steady stream of arriving communications at the server computer 301. The objective of the matching 414, therefore, is to detect which user performed a knocking, thumping or slapping action on which vending machine 101 using source information provided in the communications in conjunction with various matching criteria. The matching 401 may employ a variety of heuristics, including, for example, location of occurrence, time of occurrence, magnitudes of detected signals, profile of the signals, cross-correlation between the signals, spectral content of signals such as, for example, bandwidth and center frequency, power spectral density functions of the signals, direction of application the knocking, thumping or slapping action, etc.

With continuing reference to FIG. 2, when a match is detected, server computer 301 sends an authorization message to the matched vending machine 101 indicating that the vending machine 101 is authorized to dispense goods, block 416. Although the operation of only one vending machine 101 is shown, in practice a plurality of vending machines will exist and the authorization message indicating that vending machine 101 can dispense goods is only sent 416 to those vending machines on whom a matched user action has been detected as described above. Further, this message may also be sent over a secure communications channel, may be encrypted or otherwise secured in such a manner as to both confirm the authenticity of the source of the message to the vending machine as well as to confirm that the message has not been tampered with. Moreover, the sending 416 may also include the additional sub-step of server 301 confirming whether the matched user, as indicated by the identification information associated with mobile phone 201 that was matched, is allowed to obtain vending services. For example, this confirmation may constitute checking a user account to verify if payments are overdue, checking a database or a list to verify if the user is to be blocked from service because of past actions, checking whether the user is of legal age to allow purchase of items such as alcoholic beverages and cigarettes, etc. This checking of the user, if performed, would be conducted prior to server computer 301 sending the message to the vending machine authorizing dispensation of goods to that user and may be followed by alerts or notifications sent to appropriate operators or entities such as, for example, the local vending service operator or a payment processing company.

Upon receipt of the authorization message, block 418, vending machine 101 enables dispensation of goods and indicates to the user that it is ready to dispense goods according to the user's selection, block 420. This indication 420 may include, e.g., lighting up selection buttons, displaying currency amounts as if the user has user has inserted actual currency, and/or displaying a message. The indication 420 may be achieved by control module 104 receiving the authorization message from server computer 301 via the communications device 103 and either directly operating the controls of vending machine 101 or sending appropriate messages to a Vending Machine Controller (VMC) (not shown) which provides centralized command and control functionality for vending machine 101. Such VMCs are common in modern vending machines and well-known in the art. Further, enabling and indicating 420 may also include the sub-step of vending machine 101 performing appropriate authenticity checks on the received authorization message to verify the source of the message as well as the contents of the message.

With continuing reference to FIG. 2, a user selection of the object desired to be dispensed is received by vending machine 101, block 422. The user may select the object by operating a standard vending machine 101 control. Alternatively, the user could make the selection by further knocking or thumping actions or patterns that indicate the object desired in a pre-determined manner, such as, for example, repeated thumps to indicate row and column numbers of the object or knocking or thumping on a picture or graphic representing the item. Vending machine 101 dispenses the object selected by the user, block 424.

A confirmation message indicating successful dispensation as well as the particular object dispensed is sent from vending machine 101 to server computer 301, block 426. This confirmation message is sent by control module 104, via communications device 103, and may, for example, be generated upon control module 104 detecting through the VMC that an object has been dispensed. As before, the confirmation message may be sent 426 over a secure communications channel, may occur in encrypted form and/or may, e.g., include steps to mutually authenticate the communicating devices.

Server computer 301, upon receipt of the confirmation message, charges the user for the object dispensed, block 428. The charging 428 may be accomplished by a variety of means, including, for example, charging an online account set up the user, adding a charge to the user's mobile telephone bill, direct debiting from the user's bank account etc.

As can be seen, embodiments of system 100 and method 400, as described herein, solve the fundamental challenges outlined earlier with existing vending machine human interfaces. By allowing for a cashless transaction, embodiments describe herein ensure consumer convenience. Moreover, by enabling the transaction to be charged to a variety of online and other accounts with the possibility of micro-payments, embodiments avoid the high transaction costs associated with credit-card transactions. Further, by reducing the action of buying from a vending machine to the simple act of knocking, thumping or slapping the vending machine and nothing more, embodiments ensure a simple, easy-to-use and intuitive interface.

With the base operation described above, enhancements that add to the robustness of embodiments are considered. For example, after vending machine 101 has received 418 an authorization message, control module 104 may implement a timeout function, which cancels the entire purchase and returns vending machine 101 to the initial state if the user does not make a selection within an appropriate time period. Such an enhancement will handle cases where a user changes his mind after performing the initial action of knocking, thumping or slapping the machine, and decides to buy nothing after all, and walks away from the machine. In such a scenario, the timeout will prevent another user from obtaining a dispensation from the vending machine based on the authorization received for the first user, and thus having the purchase charged to the first user's account.

The steps described in the above embodiment of method 400 should not be construed as necessarily occurring in sequential order. Some of the steps may occur simultaneously and some may occur in practice in a different sequence than that described without having material effect on the operation of system 100. Likewise, some steps may be omitted.

Furthermore, additional variations that build upon the central theme presented in the above embodiment and add further advantages to embodiment may also be included. Several such enhancements are presented in the embodiments described below.

With reference now to FIG. 3, shown is a simplified embodiment of a method 500 for interactive use of automated vending machines. In method 500, the enabling 420 dispensation after receipt 418 of the authorization message is skipped. In this embodiment, vending machine 101 is permanently in a state of being ready to dispense goods. Consequently, the user performs the knocking, thumping or slapping action 402 and the selection 422 of the object desired consecutively. Subsequent steps of sensing 404, converting 410 and sending 412 the action, authorizing dispensation 416, dispensing 424 the product, confirming 426 the dispensation and charging 428 the user may be performed as described above. The user selection 422 of the object desired, may happen in parallel with other steps, as indicated in FIG. 3. Method 500 eliminates the need for the user to knock, thump or slap vending machine 101 and then wait for an indication from the machine; instead, the user can perform the actions of knocking, thumping or slapping vending machine 101 in a natural sequence.

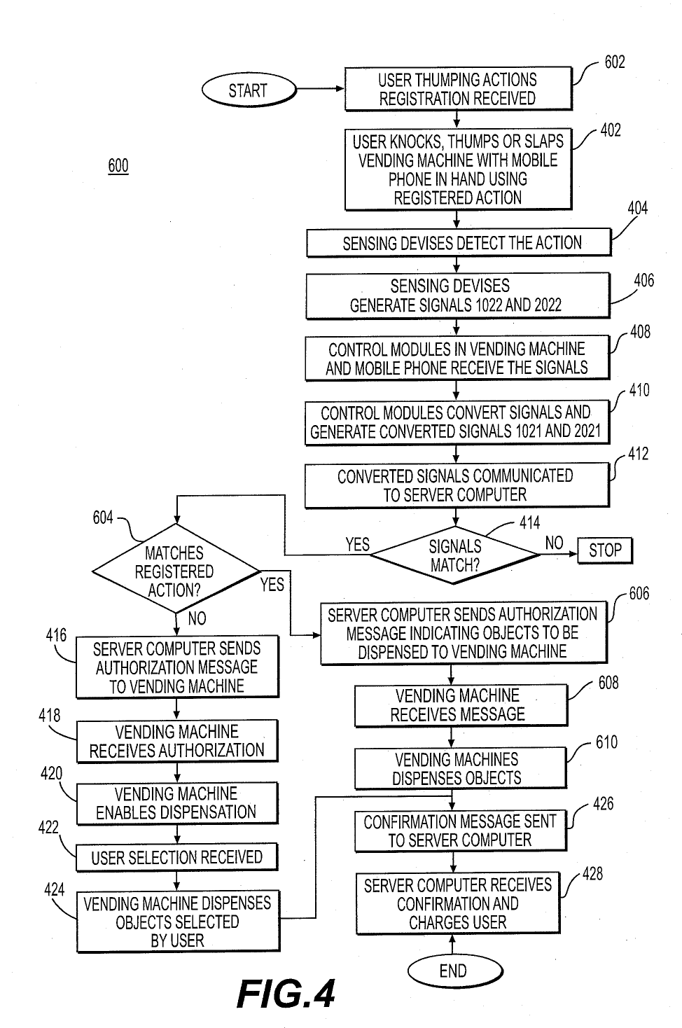

With reference now to FIG. 4, shown is an embodiment of method 600 for interactive use of automated vending machines that provides a customizable interface for the user. In this embodiment, server computer 301 receives a user registration of a pre-determined thumping action and the object that the user desires to be dispensed when that pre-determined thumping action is performed, block 602. The thumping action may be defined, e.g., as a sequence of multiple thumps, as short or long duration thumps, a combination of both, a sequence involving multiple thumps in different locations on the machine akin to a short drumming sequence, any combination of all of the above, or virtually any combination, sequence or number of thumps possible. The registration 602 may include the user using a computer to login to his/her account in server computer 301 over, for example, the Internet. Alternatively, registration 602 may also include the user registering by using a mobile phone and accessing server computer 301.

An interface in server computer 301 that allows the user to perform this registration may, e.g., be constructed to enable the user to make definitions of the thumping action by selection of items from menu choices. Alternatively, the interface could also allow the user to perform the thumping action with a mobile phone and record the sequence directly. The user may also, using the same registration procedure, register multiple sequences, each with a corresponding object to be dispensed. Furthermore, the registration may be for use on a general basis, i.e., to indicate that the association is valid in all vending machines, restricted to certain vending machines only, or, restricted on a time-of-day basis, i.e., to indicate that a certain product is to be dispensed in response to a certain thumping action in certain times of the day. Subsequent steps 402-428 may be performed in a manner to similar to that described in the embodiments described above with the exception that the user does not perform a separate selection 422 of the object to be dispensed, but rather performs in 402 a thumping action corresponding to one of the pre-determined sequences defined in registration 602. Accordingly, in matching 414, server computer 301 matches the user with the vending machine as in prior embodiments. Server computer also matches the thumping action performed by the user with one of the pre-determined sequences registered by the user, block 604. If a match with a pre-determined sequence is found, authorization message is sent to vending machine 101, block 606. Authorization message sent 606 also indicates the product to be dispensed. Vending machine receives the authorization message with indicated product, block 608, and directly dispenses the item desired by the user without requiring an explicit selection of the product by the user, block 610. If no match with a pre-registered sequence is found, the operation of the system reverts that described in the prior embodiments, i.e., allowing the user to make a selection 422 and then dispensing the product selected.

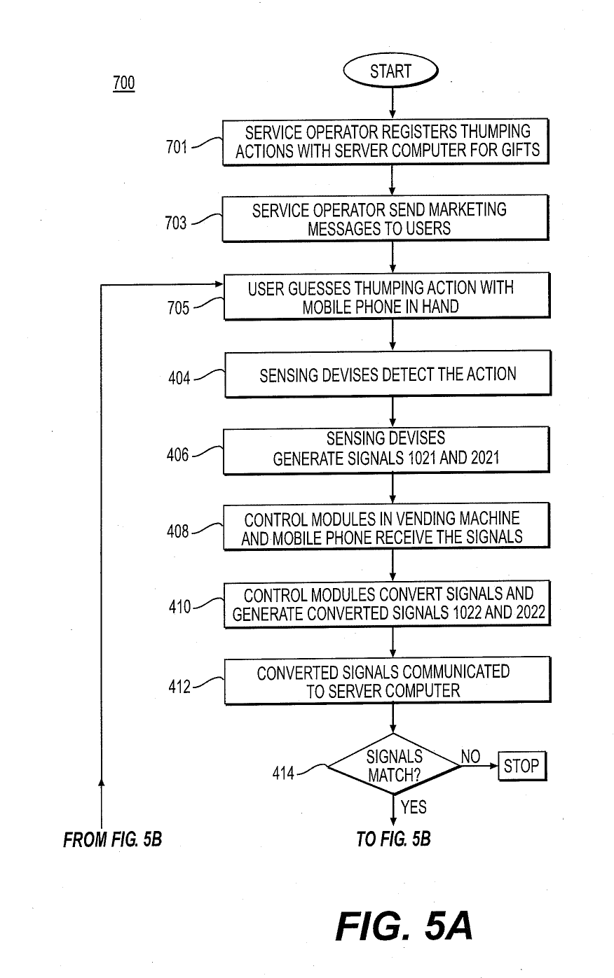

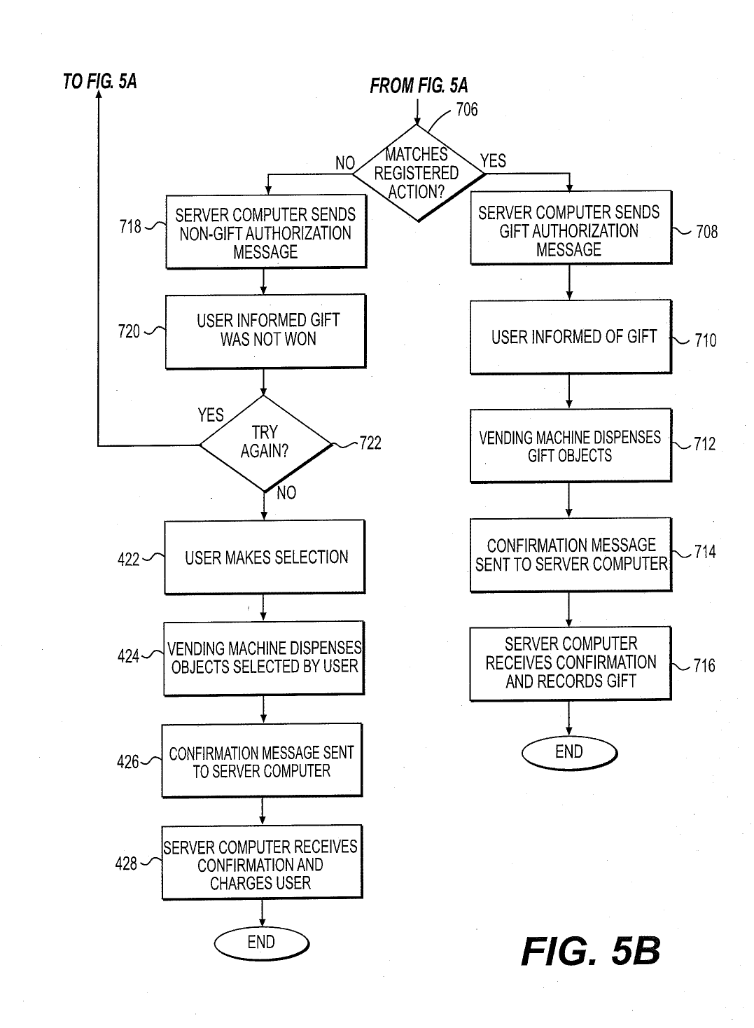

With reference to FIG. 5, shown is an embodiment of a method 700 for interactive use of automated vending machines that allows the operator of the vending service to conduct innovative marketing campaigns. In this embodiment, the vending service operator first registers with server computer 301 a pre-determined thumping action that when performed by a particular user or users will elicit a gift or a free product from one or more vending machines, block 701. The registration and definition of the thumping action may be accomplished in multiple ways, as described with reference to method 600 in FIG. 4. After registration 701, vending service operator sends a marketing campaign message to a particular user or users that states they are entitled to a gift if they can determine the particular thumping action to be performed (or simply if they perform the particular thumping action), block 703. The message may also include clues as to the action that will elicit the gift, such as, for example, the number of thumps involved. Alternatively, the message may directly inform the user of the action that will elicit the gift. Such a marketing message may be delivered directly to the mobile phone of the user, posted prominently in a user's login page in an online account, or advertised elsewhere. These two steps enable the vending service operator to achieve several objectives such as, for example, rewarding its loyal users, creating further incentives for users to continue using the service, promoting new products, and other such marketing objectives. To that end, the vending service operator may, for example, select users eligible to participate in such a campaign according to several criteria, such as those with highest purchases. Alternatively, the users could be, conversely, those who have not made a “thump-based” purchase at all, in order to incentivize and attract such users. Additionally, operators may make the campaign a chance event by, for example, rewarding every 100^{th} user. It is seen that embodiments automatically enable an opportunity for the vending service operator to construct engaging and highly targeted marketing campaigns and, therefore, provides an additional advantage to both the vending service operators as well as to users.

With continuing reference to FIG. 5, after the vending service operator has registered 701 a pre-determined action that will elicit gifts and sent 703 a marketing message, the user tries to guess the action or performs the action in the initial thumping, block 705. The action of the user is sensed, processed and communicated to server computer 301, as described in prior embodiments. Server computer 301 matches 414 the user with the vending machine as in prior embodiments. Server computer also matches the thumping action performed by the user with one of the pre-determined sequences registered by the vending service operator as being eligible for a gift, block 706. If a match is found, an authorization message indicating the product to be dispensed as a gift is sent to vending machine 101 (e.g., if the gift consists of a free product dispensation), block 708. The user is informed that he/she has just won a gift, block 710. The user may be informed through server computer 301 sending a message to user's mobile phone 201, or by vending machine 101 presenting the information in a display device located in vending machine 101. Subsequently, if the gift consists of a free product dispensation, the gift product is dispensed, block 712, and vending machine 101 confirms a gift dispensation, block 714. Server computer 301 records the gift dispensation but does not charge the user, block 716. Alternatively, if the gift is of a different nature such as, for example, a free vacation, then server computer 301 may send a message to the vending machine 101 indicating that a gift has been won but no product is to be dispensed (e.g., in block 708). Alternatively, server computer 301 may skip sending 708 this message to vending machine altogether since in this case there is no product to be dispensed and the objective of informing the user of his win need not involve the vending machine 101. In this embodiment, server computer 301 informs the user that he has won a gift, e.g., through the user's mobile phone or through a display device in the vending machine 101 (e.g., in block 710). Subsequently, server computer 301 records the fact that the user has won the gift so that further action to send the user the gift that has been won may be taken (e.g., in block 716).

If a match is not achieved, then an authorization message is sent indicating that there is no gift to be dispensed, but rather only that the vending machine is authorized to dispense products according to user's selection, block 718. User is informed that his action did not match the pre-determined gift action, block 720. The user may be informed through server computer 301 sending a message to user's mobile phone 201, or by vending machine 101 presenting the information in a display device located in vending machine 101. User is prompted to either try again, or proceed with a product selection and dispensation as before, block 722. The prompting 722 of the user may be achieved either through control module 204 in the user's mobile phone 201, or it may be achieved through an input device such as, for example, a button or a keypad in vending machine 101. Alternatively, the user's intent may also be sensed directly if he performs the thumping action again and the prompting can be skipped. If the user decides to try again then the entire process may be repeated. If the user decides not to try again, then he can proceed with a product selection and dispensation procedure as described above.

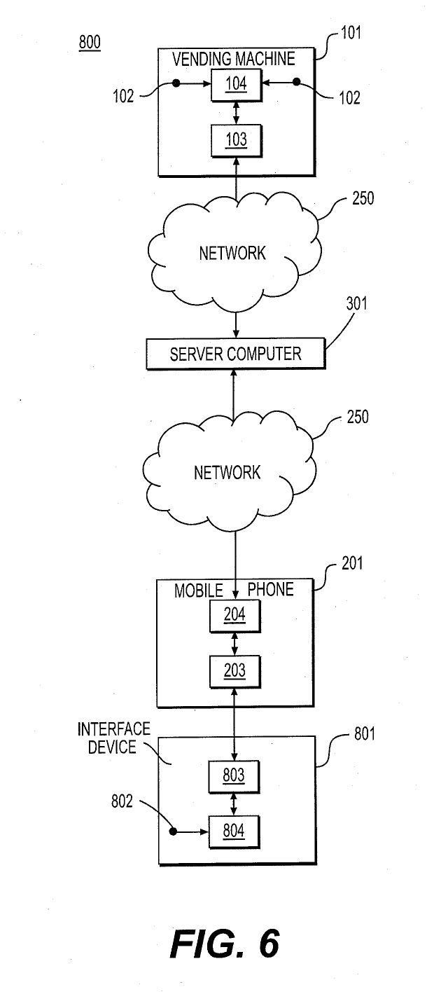

With reference now to FIG. 6, shown is an embodiment of a system 800 for interactive use of automated vending machines. In this embodiment, the user is provided with an interface device 801 that is equipped with both sensing devices 802 as well as a communications device 803. Interface device 801 is also equipped with a control module 804 which may, for example, be a software program, which is operationally coupled to both sensing devices 802 and communications device 803. Interface device 801 may, for example, be a wearable jewelry item such a bracelet or a ring or a wristwatch. Alternatively, interface device 801 may also, for example, be a key fob or special device attached to the user's key, ring or key chain. Sensing devices 802 are similar to sensing devices 102 and 202 described earlier and are capable of sensing acceleration resulting from the application of a sudden force such as that resulting from a knock, thump or a slap applied by human fist or hand against a surface. Sensing devices 802 may, for example, be MEMS-based accelerometers. Communications device 803 is a wireless communications device capable of communicating wirelessly over relatively short distances with an equivalent device 203 located in the user's mobile phone 201. Such short-range wireless communications devices are well-known and may, for example, be Bluetooth wireless devices. With this equipment, it is seen that the requirement of the user holding the mobile phone 201 in his hand while performing the knocking, thumping or slapping action on vending machine 101 is eliminated. This is because interface device 801 that the user either wears in his hand or holds naturally in his hand can perform the same sensing action and communicate the sensed signals to the user's mobile phone 201 over the short-range wireless link enabled by communications devices 203 and 803. Consequently, all of the methods of operation described above are enabled while the user keeps his mobile phone in a pocket or in a holster without needing to take it out and hold it in his hand. Thus, the system described in this embodiment makes it even easier for the user to operate the vending service through the simple action of knocking, thumping or slapping the vending machine alone while wearing or holding interface device 801.

Other additions to embodiments are possible. For example, vending machine 101 may be equipped with display devices for a variety of functions ranging from advertising the availability of the thumping interface through, for example, a sticker, to providing various indications and messages through more sophisticated active display screens. As another example, vending machine 101 may be equipped with speakers or more sophisticated music-playing devices which play a short tune or music clip in response to thumping actions, or matches, or gifts. Moreover, the user may be allowed to customize the tune or music played by such a device. Yet another example is to equip vending machine 101 with a short-range wireless communication device such as, for example, a Bluetooth device, capable of communicating with equivalent devices in the user's mobile phone 201. Vending machine 101 can then identify and communicate with the user's mobile phone via such a short-range wireless communications link. This capability may be used for a variety of purposes ranging from aiding the match heuristics performed in the server computer, to displaying personalized messages to the user on a display device located in the vending machine. Such personalized messages may, for example, be a welcome message to the user as he approaches the vending machine, or, a marketing message indicating that the user can win a free gift, etc.

It is noted that while the use of the term “vending machine” in the above embodiments and descriptions may evoke vending machines that dispense beverages, candy and other such similar items, the system and method described above is equally applicable in a number of other scenarios involving machines that vend items in general. One such example is an automated gasoline pump. The embodiments described herein may be applied with equal effect is gasoline pumps as well. Another such example is ticket vending machines in train stations or bus terminals. Further examples are arcade game machines that allow a user play a game, or juke boxes that allow a user to play music, or laundromat machines for washing and drying. Consequently, the term vending machine used herein refers to the broad class of machines that vend items or services.

As is illustrated herein, the system and method for interactive use of automated vending machines may be implemented in various embodiments. For example, an embodiment of a system may include one or more vending machines, one or more human interface devices capable of being held by, worn by, or carried in or on the person of a human, and a server computer, in which each of the one or more vending machines is equipped with one or more first sensing devices capable of detecting forces exerted by a human on an external surface of the vending machine, a first communications device capable of communications between the vending machine and the server computer, and a first control module coupled to at least the one or more first sensing devices and the first communications device. Each of the human interface devices may include one or more second sensing devices capable of detecting forces exerted on a surface by a human while the human interface device is held, worn or carried, a second communications device capable of communications between the human interface device and the server computer, and a second control module coupled to at least the one or more second sensing devices and the second communications device. In embodiments, the sensing devices may be accelerometers and the human interface devices may be mobile phones, key fobs, bracelets, rings, wristwatches, or items worn on the hand. The vending machines may be further equipped with devices capable of playing audio or with display devices, and each of the human interface devices may include a display device. Each of vending machines and human interface devices may be equipped with short-range wireless devices capable of detecting and identifying other similar short-range wireless devices in the vicinity.

Likewise an embodiment of a method for interactive use of automated vending machines may include exerting a force on an external surface of a vending machine while holding, wearing, or carrying a human interface device, detecting the force in sensing devices located in the vending machine, generating a signal from the sensing devices corresponding to the force, detecting the force in sensing devices located in the human interface device, generating a signal from the sensing devices in the human interface device corresponding to the force, processing of the signals to generate processed signals, the processing adding information that uniquely identifies the vending machine and the human interface device, communicating the processed signals from the vending machine to a server computer either directly or indirectly through other communications devices or networks, detecting a match between the processed signals at the server computer in order to infer an association between the vending machine, the human interface device, and occurrence of the force, communicating an authorization message from the server computer to the vending machine either directly or indirectly through other communications devices or networks, verifying the authorization message and enabling dispensation of goods at the vending machine upon successful verification of the authorization message, and receiving a selection of one or more objects to be dispensed, dispensing the one or more objects, communicating a confirmation message from the vending machine to the server computer either directly or indirectly through other communications devices or networks, the confirmation comprising indication of the dispensation of the one or more objects, and charging of a user for the dispensation at the server computer. The processing may compress the signals and may add information on the physical location of the vending machine, on physical location of the human interface device, on direction and an associated co-ordinate system of the signals, time of generation of the signals, describing the signals as time-varying functions, describing statistics of time variation of the signals, the statistics consisting one or more of mean, maximum, minimum and standard deviation, on the magnitude, duration, energy, spectral content or power spectral density of the signals, on the proximity of one or more human interface devices, and/or on the proximity of one or more vending machines.

The embodiment may also include one or more short-range wireless devices in the vending machine detecting and identifying a short-range wireless device located in the vicinity of the vending machine or one or more short-range wireless devices in the human interface device detecting and identifying a short-range wireless device located in the vicinity of the human interface device. The method may also display a visual indication or message pertinent to a user in possession of a short-range wireless device. The communicating may be conducted over a secure communication channel, the secure communication channel providing facilities to encrypt the communication messages, authenticate communicating endpoints, authenticate the communication message sources, and/or verify the integrity of communication messages. Likewise, the detecting a match between the processed signals may be achieved by comparing information on the physical location of the vending machine to information on the physical location of the human interface device, comparing information on respective directions, times of generation, descriptions as time-varying functions, statistics of time variation, magnitudes, durations, energies, spectral contents, and/or power spectral densities of the signals, and/or comparing information on the proximity of one or more of the vending machines. The charging of a user for the dispensation may include charging a mobile phone account of the user, charging an account of the user, debiting funds from the bank account of the user, or charging a credit card account of the user. The method may further include playing audio or displaying a visual indication/message at the vending machine and/or the human interface device upon the exerting a force, performing a verification of the authorization message, and/or dispensing of the one or more objects.

Another embodiment of a method for interactive use of automated vending machines may include a user exerting a force on an external surface of a vending machine while holding, wearing, or carrying a human interface device in a hand, receiving a selection of one or more objects to be dispensed, detecting the force in one or more sensing devices located in the vending machine, generating a signal from the one or more first sensing devices corresponding to the force, detecting the force in one or more sensing devices in the human interface device, generating a signal from the one or more sensing devices in the human interface device corresponding to the force, processing of the signals, at the vending machine and human interface device, respectively, to generate processed signals, the processing adding information that uniquely identifies the vending machine and information that identifies the one or more objects to be dispensed, and the processing adding information that uniquely identifies the human interface device, respectively, communicating the processed signals from the vending machine and the human interface device, respectively to a server computer either directly or indirectly through other communications devices or networks, detecting a match between the processed signal from the vending machine and the processed signal from the human interface device at the server computer in order to infer an association between the vending machine, the human interface device, and occurrence of the force, communicating an authorization message from the server computer to the vending machine either directly or indirectly through other communications devices or networks, verifying the authorization message at the vending machine, dispensing the one or more objects upon successful verification of the authorization message, communicating a confirmation message from the vending machine to the server computer either directly or indirectly through other communications devices or networks, the confirmation including an indication of the dispensation of the one or more objects, and charging of a user for the dispensation at the server computer.

Embodiments of the method may include registering actions of a user with a server computer, each registration specifying an association between a manner of applying a force and one or more objects to be purchased, the specifying capable of being further qualified by one or more specification qualification parameters, detecting a match between the processed signals and a manner of applying force in one of the registrations of actions at the server computer in order to infer an association between the vending machine, the human interface device, occurrence of the interaction force, and one of the registrations of actions, identifying one of the registrations of action as the matched registration of action, identifying one or more objects to dispensed in accordance with the specification in the matched registration of action and, if the specification is further qualified by the one or more specification qualification parameters, in accordance also with the one or more specification qualification parameters, and communicating an authorization message from the server computer to the vending machine, the authorization message including indication of the one or more objects to be dispensed. The specification qualification parameters may include the time of the day such that one or more of the registrations of actions specifies an association between a manner of applying a force and one or more objects to be purchased in certain time periods of the day. The specification qualification parameters may include a list of one or more vending machine attributes, such that one or more of the registrations of actions specifies an association between a manner of applying a force and one or more objects to be purchased in certain vending machines.

Embodiments of the method may include registering actions of a user with a server computer, each registration specifying an association between a manner of applying a force and one or more objects to be gifted, the specifying capable of being further qualified by one or more specification qualification parameters, communicating an authorization message from the server computer to the vending machine, the authorization message comprising indication of the one or more objects to be dispensed based on a matched registration and the specified objects to be gifted, and dispensing the one or more objects to be gifted.

Methods described herein may be executed as computer software programs including instructions to perform the methods, steps and actions described herein. The instructions may be stored on computer-readable media, such as memory or secondary storage devices (e.g., hard-drives), on vending machines, mobile phones and other human interface devices, server computers, etc, and executed by processors on such devices.

Further enhancements and added features to embodiments described herein will readily occur to those well versed in the art. All such modifications, changes, extensions, variations and other uses and applications which do not depart from the spirit and scope of the embodiments described herein are deemed to be covered by the foregoing description and the claims which follow.

1. A system for interactive use of automated vending machines comprising:
a server computer;
one or more vending machines, wherein each of the one or more vending machines includes:
one or more first sensing devices capable of detecting forces exerted on an external surface of the vending machine;
a first communications device capable of communications between the vending machine and the server computer; and
a first control module coupled to at least the one or more first sensing devices and the first communications device; and
one or more human interface devices capable of being held by, worn by, or carried in or on the person of a human, wherein each of the human interface devices includes:
one or more second sensing devices capable of detecting forces exerted on a surface while the human interface device is held, worn or carried;
a second communications device capable of communications between the human interface device and the server computer; and
a second control module coupled to at least the one or more second sensing devices and the second communications device.

2. The system of claim 1 wherein the first sensing devices and the second sensing devices are accelerometers.

3. The system of claim 1 wherein the human interface devices are mobile phones.

4. The system of claim 1 wherein the human interface devices are one or more of key fobs, bracelets, rings, wristwatches, or items worn on the hand.

5. The system of claim 1 wherein the one or more vending machines is further equipped with one or more of devices capable of playing audio.

6. The system of claim 1 wherein each of the one or more vending machines is further equipped with one or more of display devices, the each of the one or more human interface devices further comprises a display device.

7. The system of claim 1 wherein:
each of the one or more vending machines is further equipped with one or more first short-range wireless devices capable of detecting and identifying other similar short-range wireless devices in the vicinity; and
each of the human interface devices further comprises one or more second short-range wireless devices capable of detecting and identifying other similar short-range wireless devices in the vicinity.

8. A method for interactive use of automated vending machines comprising:
detecting a force exerted on an external surface of a vending machine;
generating a first signal corresponding to the force;
communicating the first signal from the vending machine to a server computer;
receiving a second signal from the human interface device at the server computer, wherein the second signal is generated in response to the force being detected in a human interface device;
detecting a match between the first signal and the second signal, wherein the match indicates an association between the vending machine, the human interface device, and the force;
communicating an authorization message from the server computer to the vending machine;
receiving the authorization message at the vending machine; and
subsequent to receiving the authorization message, dispensing one or more selected objects the one or more objects.

9. The method of claim 8 further comprising:
processing the first signal to generate a first processed signal, the processing comprising adding information that uniquely identifies the vending machine, wherein communicating the first signal from the vending machine communicates the first processed signal; and
processing the second signal to generate a second processed signal, the second processing comprising adding information that uniquely identifies the human interface device, wherein the method further comprises communicating the second processed signal from the human interface device to the vending machine server computer.

10. The method of claim 8 further comprising:
performing a verification of the authorization message at the vending machine and enabling dispensation of goods at the vending machine upon successful verification of the authorization message.

11. The method of claim 8 further comprising:
communicating a confirmation message from the vending machine to the server computer, the confirmation including an indication of the dispensation of the one or more objects; and
charging the user for the dispensation through the server computer.

12. The method of claim 8 wherein the communicating from the vending machine to a server computer is either directly or indirectly through other communications devices or networks.

13. The method of claim 9 wherein the processing of the first signal further comprises compressing the first signal and processing the second signal further comprises compressing the second signal.

14. The method of claim 8 comprising the further step of detecting and identifying at one or more first short-range wireless devices located in the vending machine a second short-range wireless device located in the vicinity of the vending machine but not located in the vending machine.

15. The method of claim 8 comprising the further step of detecting and identifying at one or more third short-range wireless devices located in the human interface device a fourth short-range wireless device located in the vicinity of the human interface device but not located in the human interface device.

16. The method of claim 14 comprising the further step of displaying at one or more display devices located in the vending machine, or at the human interface device, or at both, a visual indication or message pertinent to a user in possession of the second short-range wireless device.

17. The method of claim 8 further comprising:
detecting the force in a human interface device carried by a user; and
generating a second signal corresponding to the force detected in the human interface device.

18. The method of claim 9 wherein the processing of the first signal or processing of the second signal further comprises adding one or more of:
information on physical location of the vending machine or the human interface device;
information on direction and an associated co-ordinate system of the first signal or second signal;
information on time of generation of the first signal or second signal;
information describing the first signal or second signal as a time-varying function;
information describing statistics of time variation of the first signal or second signal, the statistics consisting one or more of mean, maximum, minimum and standard deviation;
information on magnitude of the first signal or second signal;
information on duration of the first signal or second signal;
information on energy of the first signal or second signal;
information on spectral content of the first signal or second signal; and
information on power spectral density of the first signal or second signal.

19. A system for interactive use of automated vending machines comprising:
a server computer;
one or more vending machines, wherein each of the one or more vending machines includes:
one or more first sensing devices capable of detecting forces exerted on an external surface of the vending machine, wherein when a user exerts a force on the external surface of a vending machine, the one or more sensing devices detects the force and generates a first signal indicative of the force;
a first communications device capable of communications between the vending machine and the server computer, wherein the first communications device communicates the first signal to the server computer; and
a first control module coupled to at least the one or more first sensing devices and the first communications device, and
wherein the server computer receives a second signal indicative of the force and compares the first signal to the second signal, and if there is a match between the first signal and the second signal, the server computer communicates an authorization message to the first control module authorizing the vending machine to dispense items selected by a user.

20. The system of claim 19 wherein the first control module processes the authorization message and enables the vending machine to dispense items selected by a user.
